(19) United States
(12) Patent Application Publication
(10) Pub. No.: US 2003/0090682 A1
(43) Pub. Date: May 15, 2003

(54) Positioning in computer aided manufacturing by measuring both parts (cameras, retro reflectors)

(76) Inventors: Richard Michael Gooch, Surrey (GB); Miles Sheridan, Dublin (IE); Richard John Rennie Alexander, Worcestershire (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/070,900

(22) PCT Filed: Aug. 30, 2001
(86) PCT No.: PCT/GB01/03878

(30) Foreign Application Priority Data
Sep. 13, 2000 (GB) 0022444.4

(51) Int. Cl. G01B 11/14

(52) U.S. Cl. 356/620

(57) ABSTRACT

A positioning system for use in computer aided manufacturing comprising at least one measurement means (4, 5, 6a, 6b) arranged to generate information relating to the position and orientation of a first part (2; 23), the system further comprising a processor means (5), arranged to receive the generated information, and a first handling means (21) being arranged to manipulate the first part in response to the processor means, characterised in that the at least one measurement means (3, 5, 6a, 6b; 4, 5, 6a, 6b) is further arranged to generate information relating to the position and orientation of a second part (1; 24) separate from the first part, the processor means being further arranged to derive the position and orientation of the first part relative to the measured position and orientation of the second part, and the first handling means being arranged to manipulate the first part into a predetermined position and orientation with respect to the second part in dependence on the derived relative position and orientation of the first part.

The present invention relates to a system and method of positioning one part with respect to another, particularly, but not exclusively, in a large scale industrial manufacturing or assembly operation.

In conventional large scale industrial assembly processes, such as are employed in the aircraft industries, or dockyards, there is frequently a requirement to assemble parts to large structures, or to machine large structures in a geometrically controlled manner.

In the case of large structures, such as an aeroplane fuselage section or the hull of a ship, where the structure is often assembled in situ, the actual position and orientation of the structure, or of a localised area on the structure may not be accurately known. This problem is often exacerbated due to the fact that such a structure may flex under its own weight, resulting in greater uncertainty as to the exact position and orientation of a localised area.

Furthermore, because of the large size of such structures, robots and machines which are used to assemble or manufacture such structures must be brought to the structure. Therefore, the position and orientation of such robots and machines may not be accurately known either. This is in contrast to the accurately known positions of robots used in production line assembly processes, which are mounted in fixed locations relative to the production line, upon which the articles being assembled are accurately located. Thus, dead reckoning techniques conventionally applied to production lines and other automated assembly processes are generally not appropriate to large scale assembly processes.

Gantries may be used to allow robots to move accurately around structures being assembled or machined. However, when the structure being assembled is large, the use of gantries is often impracticable. This is because in order to ensure high positional accuracy, the gantry must be highly rigid. However, when the assembled structure is very large, the difficulty and expense of constructing a gantry, which is sufficiently large and also sufficiently rigid may be prohibitive.

Jigs and templates may be made for use on a localised area of a large structure, which pick up on datum points of the structure and allow further points defining assembly or machining locations to be located. However, accurately locating the jig on the structure may in itself cause serious difficulties, depending on the form and type of structure concerned. If a jig can not be reliably located on a structure, it is of little use in locating further points on the structure.

Conventionally, in such situations, if a part is to be assembled to a large structure, the part is generally offered up for assembly in what is initially only approximately the correct position. Various measurements may then be taken using datum points located on the part and the structure. The geometric relationship between the part and the structure is then adjusted prior to re-measuring. The final fit is therefore determined in a time consuming, iterative process of measurement and re-adjustment.

Therefore, there is a need for a system and method of controlling the position of one part with respect to another in order to carry out an assembly or manufacturing operation which overcomes one or more problems associated with the prior art.

According to the invention there is provided a positioning system for use in computer aided manufacturing comprising at least one measurement means arranged to generate information relating to the position and orientation of a first part, the system further comprising a processor means, arranged to receive the generated information, and a first handling means being arranged to manipulate the first part in response to the processor means, characterised in that the at least one measurement means is further arranged to generate information relating to the position and orientation of a second part separate from the first part, the processor means being further arranged to derive the position and orientation of the first part relative to the measured position and orientation of the second part, and the first handling means being arranged to manipulate the first part into a predetermined position and orientation with respect to the second part in dependence on the derived relative position and orientation of the first part.

Advantageously, by measuring the position and orientation of first and second parts and calculating the manner in which the first part is required to be moved relative to the second part, a geometrically optimised fit between the first and second parts may be attained, without relying upon prior knowledge of the position or orientation of either part. Thus, the present invention may be used in situations where dead reckoning is not appropriate.

Furthermore, the present invention allows one part to be positioned relative to another in a process which is not dependent upon a time consuming, iterative process of measurement and re-adjustment. This gives rise to the possibility of positioning a part relative to another in a less time consuming, and/or more accurate manner.

Preferably, the measurement of the position and orientation of either the first or the second part may be made relative to a localised area of the first or the second part. Advantageously, this allows an accurate measurement of the position and orientation of the relevant area of the part to be machined or assembled; thus allowing a geometrically optimised fit with respect to the local geometries of the interface between the two parts to be attained even if one or both of the parts are compliant.

Preferably, the system of the present invention stores CAD data relating to the first or the second part. Advantageously, this allows the position and orientation of either the first or the second part to be established from the measured position of selected points on those parts, which are fitted to a CAD model of the part using a “best fit” technique; thus determining the position and orientation of the part.

Preferably, the handling means of the present invention is a robot or similar device, thus allowing the method of the present invention to be automated.

Preferably, the measurement of the position and orientation of either the first or the second part is carried out with one or more photogrammetry system, or similar non-contact position and orientation measurement device. Advantageously, such techniques allow the measurement of the position and orientation of the parts to be assembled or machined to be determined in up to six degrees of freedom. Furthermore, the measurement may be carried out in real time, thus increasing the speed of the positioning system. Additionally, such a system, may be implemented without interfering with the movement of the handling means, which may be free to operate over a great distance range.

Advantageously, by using a photogrammetry system, or similar non-contact measurement method, the accuracy with which the position and orientation of a part may be measured does not depend on the absolute accuracy of positioning of the handling means but instead depends upon the resolution (i.e. the smallest differential point that the robot end effector may be moved to) of the robot and the accuracy of the photogrammetry system. This means that a robot, for example, with high resolution characteristics, but low intrinsic positioning accuracy may be employed. Furthermore, the robot need not be highly rigid in order to ensure that the part is manipulated in the desired position and orientation. Therefore, the present invention allows the opportunity for significant cost savings in the area of automated handling equipment.

The present invention also extends to the corresponding positioning method and products manufactured by the process of the present invention. Furthermore, the present invention also extends to a computer program and a computer program product which are arranged to implement the system of the present invention.

Other aspects and embodiments of the invention, with corresponding objects and advantages, will be apparent from the following description and claims. Specific embodiments of the present invention will now be described by way of example only, with reference to the accompanying drawings, in which:

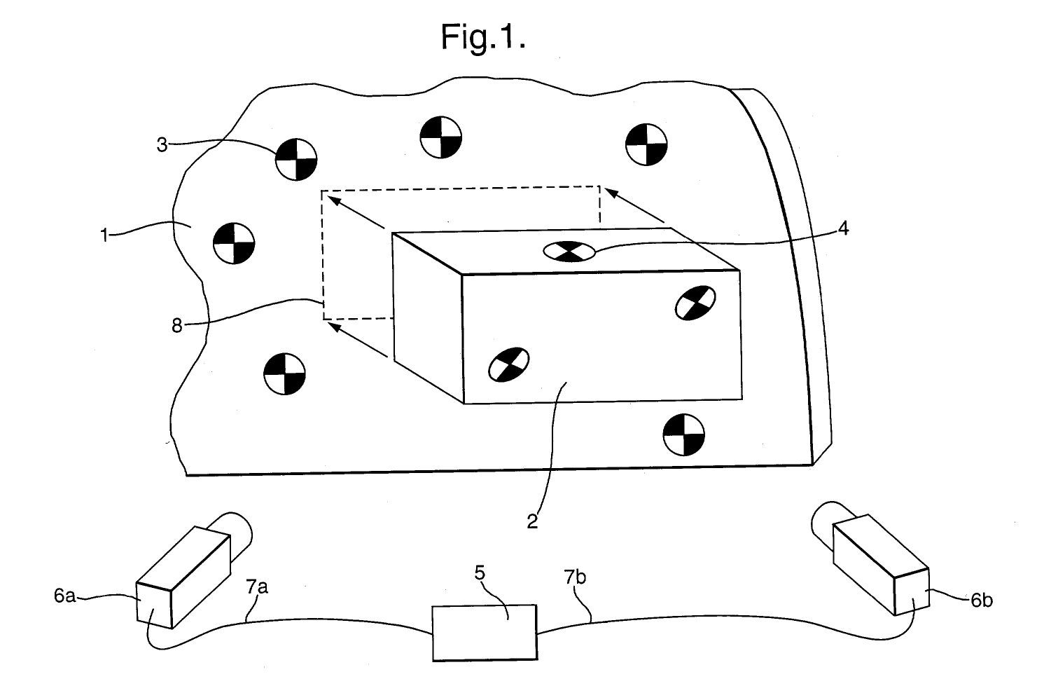

FIG. 1 is a schematic perspective illustration of the system of the first embodiment of the invention; and

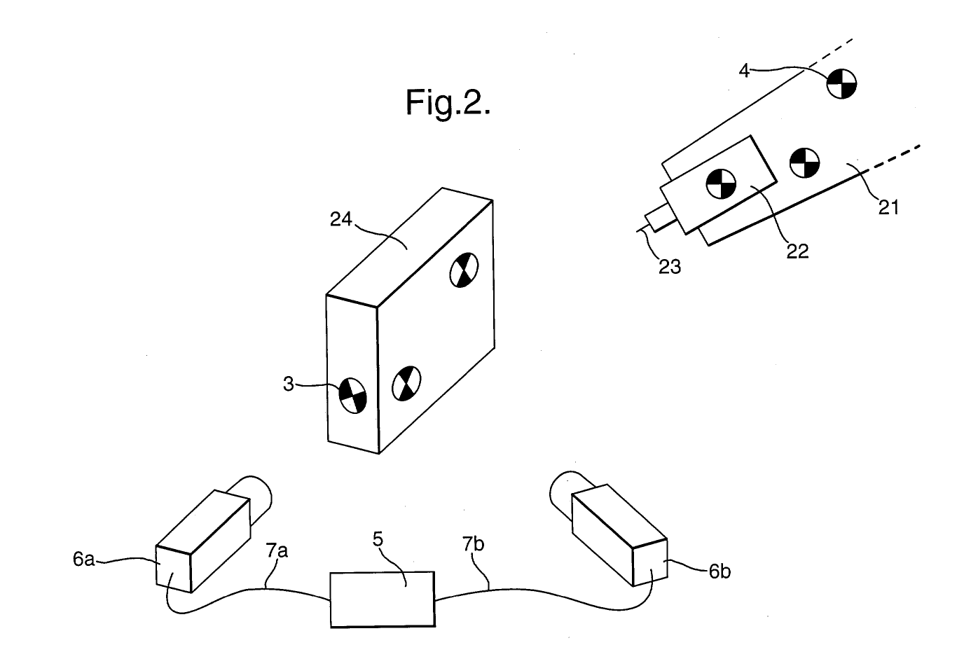

FIG. 2 is a schematic perspective illustration of the system of the second embodiment of the invention.

Referring to FIG. 1, the positioning system of the present embodiment is illustrated. In this embodiment of the invention, the positioning system is arranged to correctly position one part 2 relative to a section of an aircraft fuselage 1, such as a cockpit section, of which a fragmentary view is shown in the figure. Once the part 2 is correctly positioned with respect to the fuselage section 1 it may be correctly assembled with the fuselage section 1.

For the purposes of illustrating the invention, in this example, the part 2 has a known geometry on which it is possible to locate datum measurement positions or locations accurately. The fuselage section 1 also has a known geometry. However due to its form and size, it is difficult to locate datum measurement positions or locations sufficiently accurately to satisfy the required position tolerances of the assembly process; either on the area local to the assembly point of the two parts or on the fuselage section 1 as a whole.

The fuselage section 1 is supported in a conventional manner such that it is fixed and stable prior to the commencement of the assembly process of the present embodiment.

The part 2 is to be offered up in the required geometrical arrangement with respect to the fuselage section 1, in order that it may be fixed to the fuselage section 1 in a conventional manner, such as by drilling and riveting. The part 2 is supported by a robot (not shown), such as a Kuka™ industrial robot, equipped with a parts handling end effector. The robot is free to manipulate the part 2 in six degrees of freedom. That is to say that the robot may manipulate the part 2 in three orthogonal axes of translation and in three orthogonal axes of rotation in order to bring part 2 into the correct geometrical arrangement with the fuselage section 1, for assembly.

In the present embodiment, a processor 5, which may be a suitably programmed general purpose computer, determines the position and orientation of both the fuselage section 1 and the part 2 prior the part 2 being offered up for assembly. This is achieved using a photogrammetry system with retro-reflective targets associated with each of the fuselage section 1 and the part 2, as is described below.

The photogrammetry system is a conventional six degrees of freedom system using two conventional metrology cameras 6a and 6b, set up so as to have a field of view encompassing the fuselage section 1 and the part 2 prior to the implementation of the assembly process of the invention. The cameras 6a and 6b are connected to the processor 5 via suitable respective connectors 7a and 7b, such as co-axial cables.

Each camera 6a and 6b has associated with it an illumination source (not shown) located in close proximity with the cameras 6a and 6b and at the same orientation as its associated camera.

A number of retro-reflective targets 3, 4 are fixed in a conventional manner to the fuselage section 1 and the part 2, respectively. The targets 3, 4 are used to determine the position and orientation of the fuselage section 1 and the part 2, respectively.

In this embodiment, the targets 4 on part 2 are each located at accurately known datum measurement positions on part 2. The targets 4 are coded, using a conventional coding system, so that each target 4 may be uniquely identified. Suitable coded targets are available from Leica Geosystems Ltd., Davy Avenue, Knowlhill, Milton Keynes, MK5 8LB, UK.

However, the targets 3 on the fuselage section 1 are not coded and are not located at accurately known positions, since, as is stated above, accurately locating datum measurement positions on the fuselage section 1 is difficult to achieve due to its form and size. Therefore, the targets 3 are located approximately, about the area local to the point of assembly, which is represented by the dashed line 8 in FIG. 1. By locating the targets 3 in the area local to the point of assembly, the position of assembly may be accurately determined even if the fuselage section 1, as a whole, is compliant and flexes under its own weight.

The targets 3, 4 are attached in a fixed relationship with the fuselage section 1 and the part 2, respectively. This ensures that there is no divergence between the measured position and orientation of the targets 3, 4 and the local areas on the fuselage section 1 and the part 2 to which the targets 3, 4 were originally fixed.

Prior to instigating the assembly procedure of the present embodiment, the co-ordinate frame of reference in the measurement volume, or work cell, of cameras 6a and 6b is determined in a conventional manner. By doing so, images of the targets 3, 4 on the fuselage section 1 and the part 2 output by cameras 6a and 6b may be used to determine the position and orientation of the fuselage section 1 and the part 2 not only relative to cameras 6a and 6b but relative to a further co-ordinate frame of reference. In practice, this may be the co-ordinate frame of reference of the fuselage section 1, or of a larger assembly, of which the fuselage section 1 is a sub-assembly.

This process is typically performed off-line, and there are several known methods of achieving this. One such method relies on taking measurements of control targets which are positioned at pre-specified locations from numerous imaging positions. The measurements are then mathematically optimised so as to derive a transformation describing a relationship between the cameras 6a and 6b. Once the co-ordinate frame of reference of the cameras 6a and 6b has been derived, this is used to determine the position in three dimensions of targets 3, 4 subsequently imaged by the cameras 6a and 6b when positioned at otherwise unknown locations.

In operation, the cameras 6a and 6b receive light emitted from their respective illumination sources (not shown), which is reflected from those targets 3, 4 with which the cameras 6a and 6b and their associated light sources have a direct line of sight.

As is well known in the art, retro-reflective targets reflect light incident on the reflector in the exact direction of the incident light. In this manner, the position of each target 3, 4 may be established using two or more camera/illumination source pairs, in a conventional manner.

The cameras 6a and 6b each output video signals via connectors 7a and 7b, to the processor 5. The two signals represent the instantaneous two dimensional image of the targets 3, 4 in the field of view of cameras 6a and 6b.

Each video signal is periodically sampled and stored by a frame grabber (not shown) associated with the processor 5 and is stored as a bit map in a memory (not shown) associated with the processor 5. Each stored bit map is associated with its corresponding bit map to form a bit map pair; that is to say, each image of the targets 3, 4 as viewed by camera 6a is associated with the corresponding image viewed at the same instant in time by camera 6b.

Each bit map stored in the memory is a two dimensional array of pixel light intensity values, with high intensity values, or target images, corresponding to the location of targets 3, 4 viewed from the perspective of the camera 6a or 6b from which the image originated.

The processor 5 analyses bit map pairs in order to obtain the instantaneous position and orientation of both the fuselage section 1 and the part 2 relative to the cameras 6a or 6b. This may be carried out in real time.

The processor 5 performs conventional calculations known in the art to calculate a vector for each target image in three dimensional space, using the focal length characteristics of the respective cameras 6a and 6b. In this way, for each target 3, 4 that was visible to both cameras 6a and 6b, its image in one bit map of a pair has a corresponding image in the other bit map of the bit map pair, for which their respective calculated vectors intersect. The intersection points of the vectors, in three dimensions, each correspond to the position of a target 3, 4 as viewed from the perspective of cameras 6a and 6b; i.e. in terms of the derived co-ordinate frame of reference.

Once the positions of the targets 3, 4 visible to both cameras 6a and 6b have been determined with respect to the derived co-ordinate frame of reference, their positions are used to define the position and orientation of the fuselage section 1 and the part 2 in terms of the derived co-ordinate frame of reference. This can be achieved using one of a variety of known techniques. In the present embodiment, this is achieved in the following manner.

In the present embodiment, the three dimensional geometry of the part 2 is accurately known. This is stored as computer aided design (CAD) data, or a CAD model in a memory (not shown) associated with the processor 5. In practice, the CAD model may be stored on the hard disc drive (or other permanent storage medium) of a personal computer, fulfilling the function of processor 5. The personal computer is programmed with suitable commercially available CAD software such as CATIA™ (available from IBM Engineering Solutions, IBM UK Ltd, PO Box 41, North Harbour, Portsmouth, Hampshire P06 3AU, UK), which is capable of reading and manipulating the stored CAD data. The personal computer is also programmed with software which may additionally be required to allow the target positions viewed by the cameras 6a, 6b, to be imported into the CAD software.

As stated above, in the present embodiment, the position of the targets 4 on the part 2 are accurately known. Thus, the CAD model also defines the positions at which each of the targets 4 is located on the part 2, together with the associated code for each target 4. By defining the three dimensional positions of a minimum number of three known points on the CAD model of the part 2, the position and orientation of the part 2 is uniquely defined. Thus, the three dimensional positions of three or more targets 4, as imaged by cameras 6a and 6b and calculated by processor 5, are used to determine the position and orientation of the part 2, in terms of the derived co-ordinate frame of reference.

The targets 4 whose three dimensional positions have been calculated are then matched to the corresponding target locations on the CAD model. This is achieved by identifying from the codes on each target 4 imaged by the cameras 6a and 6b the identity of those targets in a conventional manner, and then matching those codes to target positions on the CAD model with corresponding target code data. When this has been accomplished, the target positions in the CAD model which have been matched with an identified target are set to the three dimensional position calculated for the corresponding target. When this has been done for three target positions on the CAD model, the position and orientation of the part 2 is uniquely defined.

The position and orientation of the fuselage section 1 is also determined. As is stated above, the three dimensional geometry of the fuselage section 1 is also accurately known. Again, this is stored as CAD data, or a CAD model in the memory (not shown) associated with the processor 5. However, since the exact positions of the targets 3 with respect to the fuselage section 1 is not precisely known, the locations of the targets 3 are not held in the CAD data relating to the fuselage section 1.

However, by establishing the three dimensional position of six or more non-coplanar, non-colinearly placed targets 3 on the fuselage section 1, in the co-ordinate frame of reference of the cameras 6a and 6b, the relationship between their collective three dimensional positions and the CAD data defining the fuselage section 1 may be established by calculating the “best fit” for the measured target positions when applied to the CAD data. This may be implemented using a conventional “least mean squares” technique.

Once a “best fit” has been calculated for the measured three dimensional positions of a sufficient number of the targets 3 to derive a non-degenerate solution, the position and orientation of the fuselage section 1 may be uniquely defined by setting three or more of the target positions on the CAD data to the measured three dimensional positions for the corresponding targets 3.

When the positions and orientations of the fuselage section 1 and the part 2 have been determined, the processor 5 then compares the measured position and orientation of part 2 relative to the fuselage section 1, with that which is required in order to ensure correct assembly. The required position and orientation of part 2 is illustrated by dotted line 8 in FIG. 1 and is defined by further CAD data associated with the CAD model of the fuselage section 1.

The processor 5 then calculates the degree and direction by which the part 2 must be re-orientated and translated, in a conventional manner, in order to be located in a position conforming to that required.

The processor 5 subsequently generates control signals which are transmitted to the robot (not shown) to manipulate the part 2 by the amounts calculated. In the present embodiment, the step of re-orientating the part 2 is carried out prior to the step of translating the part 2 into its final assembly position, thus helping to ensure that no accidental collision between the part 2 and the fuselage section 1 occur.

While the part 2 is re-orientated and translated, the movement of the part 2 effected by the robot is detected by the probe and used in real time by the processor 5 to modify the control instructions output to the robot, should this be required. This may be required, for example, where the robot is not able to measure the movement of its end effector over relatively long distances with sufficient accuracy for the purposes of the assembly task in question.

When the part 2 is located in the correct geometrical arrangement with the fuselage section 1, the robot is controlled by the processor 5 to hold the part 2 in the correct position whilst an operator marks out assembly location points on the fuselage section 1, such as points for drilling. During this process, the position and orientation of the fuselage section 1 and the part 2 may be continually monitored by the probes and the processor 5 in order to ensure that no relative movement occurs between the two parts during the assembly process.

Although the example given in the first embodiment described positioning a first part relative to a second, where the positions of the targets on the first part are accurately known and the positions of the targets on the second part are not, it will be appreciated that this situation in practice could be reversed. The present invention may also be implemented where the targets are located in accurately known positions on both parts; or alternatively, where the targets locations on both parts are not accurately known. Furthermore, the locations of one or more targets on either part may be accurately known, with the remainder not being accurately known.

The second embodiment of the present invention in general terms fulfils the same functions and employs the same apparatus as described with reference to the first embodiment. Therefore, similar apparatus and modes of operation will not be described further in detail. However, whereas the system of the first embodiment is arranged to position a part into a predetermined geometric arrangement with a structure to which the part is to be assembled, the system of the second embodiment is arranged to position a tool used in a manufacturing operation in a predetermined geometric arrangement with respect to the structure or part to be acted on by the tool.

Referring to FIG. 2, the positioning system of the second embodiment is illustrated. The wrist 21 of a robot similar to that used in the first embodiment is illustrated. Whereas in the first embodiment the robot was equipped with a parts handling end effector, in the present embodiment a drill 22 is rigidly mounted on the robot wrist 21. A drill bit 23 is supported in the drill 22.

A part 24 which is to be machined is also shown. The part 24 is supported in a conventional manner such that it is fixed and stable prior to the commencement of the manufacturing operation of the present embodiment.

As is described with reference to the first embodiment, retro-reflective targets 3, 4 are attached in a fixed relationship with respect to the part 24 and the tip of the drill bit 23, respectively. As the tip of the drill bit 23 is in a fixed and easily measurable geometrical relationship with the drill 22 and the robot wrist 21, the targets 4, in this embodiment may be located on the drill 22 or on the robot wrist 21, as shown. Indeed, the targets 4 may be attached to any other structure in a fixed geometrical relationship with the drill.

In the present embodiment, the targets 3, 4 may be either of the coded or non-coded variety. However, sufficient targets 3, 4 must be simultaneously visible to both of the cameras 6a and 6b in order for a non-degenerate position and orientation determination for both the drill bit 23 and the part 24 to be made.

Also shown in the figure are cameras 6a and 6b which are connected to a processor 5 by suitable connections 7a and 7b; each of which serve the same function as described with respect to the first embodiment.

In the present embodiment, the robot, including the wrist 1a, is controlled by the processor 5 to position the drill bit 23 in the correct geometrical arrangement with respect to the part 24 such that holes may be drilled in part 24 in locations specified by CAD data relating to part 24 stored in a memory (not shown) associated with the processor 5. The CAD data additionally specifies the orientations of each hole with respect to the part 24 and the depth to which the hole is to be drilled.

As was discussed with reference to the first embodiment, the processor 5 calculates the three dimensional positions of the targets 3, 4 in the derived frame of reference, using the signals output from cameras 6a and 6b. From this information the processor 5 calculates the position and orientation of both the part 24 and the drill 22, using CAD models stored in a memory (not shown) associated with the processor 5.

Once the offset distance of the tip of the drill bit 23 is input into the CAD model of the drill 22 and/or robot wrist 21, the position and orientation of the tip of the drill bit 23 may be determined. Alternatively, the position and orientation of the tip of the drill bit may be established using the photogrammetry system and method described in the Applicant's co-pending application (Agent's Reference XA1213), which is herewith incorporated by reference in its entirity)

Thus, the processor 5 may control the robot to move the drill bit 23 into precisely the correct position and orientation prior to commencing drilling each hole. The movement of the robot may the also be controlled during the drilling operation; thus ensuring that the axis of the hole remains constant throughout the drilling process and that the hole is drilled to the correct depth and at a predetermined rate.

Although the second embodiment describes the positioning of a drill relative to a work piece to be machined, the skilled reader will realise that various other tools may be manipulated using the present invention. Such tools may include milling or grinding tools, a welding device or a marking out device, such as punches, scribers or ink devices.

It will be clear from the foregoing that the above described embodiments are merely examples of the how the invention may be put into effect. Many other alternatives will be apparent to the skilled reader which are in the scope of the present invention.

For example, although the above embodiments were described using targets which were attached directly to the parts or tool/tool housing which were being positioned according to the invention, the skilled person will realise that this need not be the case in practice. For example, one or more probes, such as a 6 degree of freedom probe described in EP 0 700 506 B1 to Metronor AS which is entitled Method for Geometry Measurement, may instead be attached in a rigid fashion to one or each part or tool involved in a positioning operation according to the present invention; thus allowing the position and orientation of the respective parts or tools to be established.

As a further example, although the above embodiments were described using only one pair of cameras, it will be appreciated that more than two cameras or more than one pair of cameras may be used. For example, it may be desirable to use two pairs or sets of cameras. The first set may be used to give a six degree of freedom position of one part and the second set may be used to give a six degree of freedom position of the second part involved in the positioning operation. In this manner, the problem of the targets on one or other of the parts to be assembled being obscured by the robot or the part which the robot is manipulating may be avoided. It will of course be appreciated that if more than one set of cameras is to be used, then conventional transformations must be derived in order to relate the co-ordinate frame of reference of one set of cameras to the co-ordinate frame of reference of the other. Alternatively, transformations may be derived which relate the position information derived by each set of cameras to a further, common reference co-ordinate frame.

It will also be appreciated that although in the above described embodiments one part in the positioning procedure was held stationary and the other part was manipulated by a robot, the present invention may also be implemented with two or more parts, each of which are manipulated by a robot or similar manipulation device.

Furthermore, whereas a conventional photogrammetry system is used in the above embodiments as the position and orientation measurement system, it will be understood that other systems which may be used to yield a six degree of freedom position of a part may instead be used. For example, three laser trackers, each tracking a separate retro-reflector, or equivalent system, such as any six degree of freedom measurement device or system, could also be used. Alternatively, the measurement system could consist of two or more cameras which output images of a part to a computer programmed with image recognition software. In such an embodiment, the software would be trained to recognise particular recognisable features of the part in question in order to determine the position and orientation of the part in question in respect of the cameras.

It will also be understood that the invention may be applied to a system in which a reduced number of degrees of freedom of manipulation are required. For example, an embodiment of the invention may be implemented in which only three translation degrees of freedom, along the X, Y and Z axes, are used. Indeed, if the system of the present invention were to be implemented using a reduced number of degrees of freedom of manipulation, it will be understood that measurement devices or systems of a similarly reduced number of degrees of freedom of measurement may be used.

It will also be appreciated that although no particular details of the robot 1 were given, any robot with a sufficient movement resolution and sufficient degrees of freedom of movement for a given task may be used to implement the invention. However, the robot may be mobile; i.e. not constrained to move around a base of fixed location. For example, the robot may be mounted on rails and thus be able to access a large working area. A mobile robot may be able to derive its location through the measurements made by the processor using the output signals of a measurement device or system, thus obviating the need for any base location measurement system on the robot itself. In such an embodiment of the invention, the processor may be programmed not only to control the articulation or movement of the robot arm, but also the movement of the robot as a whole.

Furthermore, it will be also be appreciated that the processor may be suitably programmed in order to ensure that at no time does the position of the part being manipulated overlap with the position of the part with respect to which it is being positioned, thus ensuring against collisions between the two parts. In certain intricate situations, the position of portions of the robot, such as its end effector, may also need to be monitored in order to ensure that the robot does not collide with the non-manipulated part. This could be achieved by using targets located on the parts of the robot of concern and relating the position of the targets to a stored CAD model of the robot in the manner described above.

Although the above described embodiments implement the manipulation of one part relative to another under the control of a processor, it will be understood that this may be controlled by an operator inputting control entries in to processor, using for example a keyboard or a joystick. The control entries may either specify an absolute position and orientation of the robot wrist or a part being manipulated, or they may instead specify incremental position and orientation changes relative to its current position and orientation.

1. A positioning system for use in computer aided manufacturing comprising at least one measurement means (4, 5, 6a, 6b) arranged to generate information relating to the position and orientation of a first part (2; 23), the system further comprising a processor means (5), arranged to receive the generated information, and a first handling means (21) being arranged to manipulate the first part in response to the processor means, characterised in that the at least one measurement means (3, 5, 6a, 6b; 4, 5, 6a, 6b) is further arranged to generate information relating to the position and orientation of a second part (1; 24) separate from the first part, the processor means being further arranged to derive the position and orientation of the first part relative to the measured position and orientation of the second part, and the first handling means being arranged to manipulate the first part into a predetermined position and orientation with respect to the second part in dependence on the derived relative position and orientation of the first part.

2. A system according to claim 1, wherein the first or the second part is a localised area of a respective first or second structure.

3. A system according to claim 1 or 2, wherein the position and orientation the first part is derived in a first frame of reference and the position and orientation of the second part is derived in a second frame of reference, the processor means being arranged to derive the position and orientation of the first part relative to the measured position and orientation of the second part in the second frame of reference.

4. A system according to any preceding claim, wherein the positioning system is for use in aircraft manufacture.

5. A system according to any preceding claim, further comprising a memory associated with the processor means, arranged to store CAD data relating to the first or the second part.

6. A system according to any preceding claim, wherein the at least one measurement means is arranged to measure the position of the first or the second part to six degrees of freedom.

7. A system according to any preceding claim, wherein the at least one measurement means comprises at least one imaging device (6a, 6b) and at least one light source (3, 4) in a fixed relationship with the first or the second part.

8. A system according to claim 7, wherein the least one imaging device is a metrology camera (6a, 6b).

9. A system according to claim 7 or claim 8, wherein the at least one light source is a retro-reflector (3, 4).

10. A method of computer aided manufacturing, the method comprising the steps of:
measuring the position and orientation of a first part;
generating a control signal for controlling a first handling means, the first handling means being arranged to position the first part;
the method being characterised by the steps of:
measuring the position and orientation of a second part, separate from the first part;
determining the position and orientation of the first part relative to the measured position and orientation of the second part; and,
positioning the first part in a predetermined position and orientation with respect to the second part, in dependence on the derived relative position and orientation of the first part.
